(19) United States
(12) Patent Application Publication
(10) Pub. No.: US 2011/0208600 A1
(43) Pub. Date: Aug. 25, 2011

(54) Point of Sale Payment System and Method

(75) Inventors: Eldad AHARONI, Raanana (IL); Alicia ROISMAN-ISMACH, Tel Mond (IL); Gerson JOSKOWICZ, Netanya (IL)

(73) Assignee: SEERGATE LTD., Ra'anana (IL)

(21) Appl. No.: 13/024,526

(22) Filed: Feb. 10, 2011

Related U.S. Application Data
(60) Provisional application No. 61/308,198, filed on Feb. 25, 2010.

(51) Int. Cl. G06Q 20/00

(52) U.S. Cl. 705/16

(57) ABSTRACT

A point of sale (POS) payment system does not require the payor to disclose confidential and sensitive financial information to the payee in order to settle the transaction. The payee presents the payor with an invoice or bill. The payor requests from their bank (or proxy for the bank) a payment token for a predefined sum and receives the payment token electronically, such as via smart phone or other portable device. The payment token is transferred to the payee as payment for the invoice. The payee stores the electronic payment token or the data associated therewith and submits the token to the payor bank (or proxy for the bank) to settle the transaction or invoke the settlement process.

### CROSS-REFERENCE TO RELATED APPLICATIONS

This application claims any and all benefits as provided by law of U.S. Provisional Application No. 60/308,198 filed on Feb. 25, 2010, which is hereby incorporated by reference in its entirety.

### STATEMENT REGARDING FEDERALLY SPONSORED RESEARCH

Not Applicable

### REFERENCE TO MICROFICHE APPENDIX

Not Applicable

### BACKGROUND

1. Technical Field of the Invention

The present invention is directed to point of sale (POS) payment systems and methods. Specifically, the POS payment system than can provide for low cost bank to bank transfers with improved security.

2. Description of the Prior Art

Current POS payment systems provide that a payee presents an invoice or bill to the payor and the payor tenders payment in the form of a debit card, credit card or check. Following payment, the payee initiates settlement through a debit or credit card service provider or presenting the check to the payor bank. These systems have well know risks. For example, checks can be denied for insufficient funds. Credit cards require the payor to pay their credit card bill and where the payor does not pay their bill, the credit card company may debit the unpaid transaction against future payments to the payee. In addition, both credit cards and checks expose payor account numbers which can be used fraudulently.

### SUMMARY

In accordance with invention, a method and system for POS payment is provided. In accordance with the invention, a payor is presented with an invoice or bill for goods or services. The payor, using any mobile device or a local terminal, connects to the payor's bank (either directly or though an intermediate service) to request a payment token. The payment token can be any number, symbol or device that represents the authorization of a predefined amount from the payor's bank. The payment token can be presented to the payee and stored by the payee for subsequent settlement and the payee can provide an electronic or paper receipt or both. The payment token may or may not identify the payee or the payee's bank. The payee or the payee's bank can use the payment tokens to settle the transaction and cause the transfer of funds.

An intermediate service or proxy can be used to generate the payment token and to assist in the transaction settlement process. The payor can request the payment token from the proxy and the proxy can interact with the payor bank in real time to determine whether there are sufficient funds in the payor account. In addition, the proxy can instruct the payor bank to place a hold or debit the payment token amount from the payor's account. After the payor transfers the payment token to the payee, the payee or the payee's bank can present the payment token for payment, for example, such as part of a settlement process. The proxy can verify the validity of the token and the amount and instruct the payor bank to release and transfer the funds to the payee bank.

Where the proxy has an existing relationship with both the payor and the payee banks, the proxy can periodically aggregate the payments between the banks and instruct a net payment be made to settle a group of transactions.

The present invention can provide for reduced costs and reduced risk to all the parties involved. The present invention can provide for a lower transaction cost. The present invention can provide for low transaction costs. The present invention can reduce the opportunity for fraud and non-payment. The present invention can be used to replace checks and credit cards. The present invention can be implemented using a POS terminal and any mobile or fixed terminal accessible by the payor, such as a mobile phone or smart phone, PDA, notebook or laptop computer or a stationary terminal adjacent the POS.

The present invention is different from a debit card process in many aspects and similar to a cash based transaction. In the debit card process, the customer hands a debit card to the store. The store uses this card to request funds from the customer's bank—usually over an interbank network. However, the store, in processing the transaction, can collect sensitive, financial information of the customer.

In processes in accordance with the present invention, the customer takes responsibility to arrange for the payment authorization. The store does neither process nor collect sensitive financial information. The store collects a certificate signed by the customer's bank that can be immediately converted. The certificate can be checked instantaneously using the digital signature of the bank.

For this reason, processes according to embodiments of the invention are therefore more similar to a cash based transaction. The customer provides a financial instrument that is similar to cash—it can be exchanged instantaneously. As in the case of a cash transaction, the process does not require that the POS system is online; certificates can be submitted within a pre-determined validity period.

The present invention provides for improved security for the payor. While the processes according to the invention allow the customer to stay anonymous to the store, the processes provide the same or better security than a standard debit card process. For example, the payment token presented to the store clerk can also include the name of the customer. Thus facilitating the familiar debit card based process whereby the clerk can verify the identity of the customer by asking for additional identifying documents (Driver's license, etc.). Further, the payment token can include additional information or elements (such as, pictures, signatures, fingerprints, voice recognition signatures, retinal scan information) allowing the clerk to further identify the customer. In addition, the smart phone only holds configuration data, and does not hold account numbers nor PIN information, so if it is lost or stolen, unlike a debit or credit card, it does not present the same risk to the customer.

The present invention also can be used to provide additional flexibility. The information contained in any certificate, even expired certificates, can be used by the customer's bank to retrieve customer information. This feature can be used to facilitate additional processes like cash-rebates, loyalty programs, refunds, etc., enabling direct transfer of funds without the need to store sensitive financial information.

These and other capabilities of the invention, along with the invention itself, will be more fully understood after a review of the following figures, detailed description, and claims.

### BRIEF DESCRIPTION OF THE FIGURES

FIG. 1 is a block diagram of a system according to the invention.

FIG. 2 is a diagrammatic view of a process according to one embodiment of the invention.

FIG. 3 is a diagrammatic view of a process according to an alternate embodiment of the invention.

### DETAILED DESCRIPTION OF PREFERRED EMBODIMENTS

The present invention is directed to a point of sale (POS) payment system and method. In accordance with the invention, the system facilitates payment from a payor to a payee at the point of sale. The payee notifies the customer-payee of the amount due for goods and/or services rendered. The payee, using a portable devices (such as a smart phone or PDA), accesses their bank (or a proxy) and requests a payment token for the amount of payment. The payment token can be received and stored by payee system. The payee systems can use the payment token to settle the transaction. The payment token can be presented to the payee bank or their proxy to close the transaction and initiate settlement.

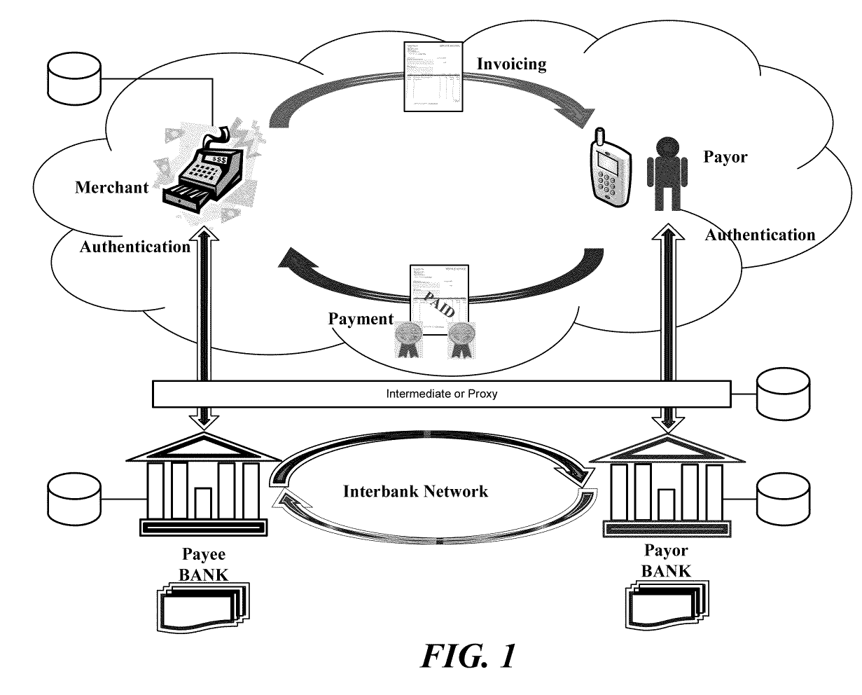

FIG. 1 shows a system for facilitating POS payments in accordance with one embodiment of the invention. The payee (merchant and/or service provider) can include an electronic system for receiving payment tokens from a customer—payor. The payor can include a smart phone or PDA or use a payor terminal provided by the merchant. The smart phone, PDA or payor terminal can include an application that enables the payor to securely connect (such as by a wired or wireless network) to their bank (or a proxy therefore) and request a payment token for a set payment amount. This can be accomplished by accessing either directly or indirectly, the computer servers at the payor bank. The payment token can be transferred to the payee, such by scanning a 2D barcode or electronically (wired or wirelessly) transferring the payment token to payee. The payee can include a POS terminal that includes systems for receiving payment tokens in the form that they are presented. POS terminal can store the payment tokens or forward the payment tokens to system storage for safe keeping. Optionally, the payee can transfer electronically a receipt to the payor as proof of payment or provide a paper receipt.

In accordance with one embodiment of the invention, an intermediate service provider or proxy can be used to generate the payment token as well as verify its validity and authorize payment. In this embodiment, the proxy provides the application to the payor and interacts with payor to receive the request for the payment token. The proxy also interacts with the payor's bank to confirm that the payor has sufficient funds to authorize the payment token, as well as enable the payor's bank to place a hold or withdraw from the payor's account the funds associated with the payment token. The proxy can also interact with the payee's bank to validate the payment token and facilitate funds transfer. Thus, for example, the payee can present the payment token to the proxy, which validates the payment token and coordinates transaction settlement by electronic funds transfer from the payee bank to the payor bank. In other embodiments of the invention, the proxy can aggregate payments of multiple bank customers between the two banks and resolve multiple transactions with a single net transfer using the interbank network. The proxy can store the payment token information in a secured database that can be used to validate payment tokens and facilitate electronic funds transfer without exposing payor and payee bank account numbers to the other party.

The payment token can be any symbol or device that can be used to represent the payment of funds from the payor's account. In one embodiment, the payment token can be a collection of information that directly or indirectly indicates the monetary amount of the payment and the source of the funds. The payment token can be digitally signed with a digital signature of the payor's bank or other organization that validates the payment token. The digital signature can serve to identify the bank or the proxy (intermediate service) that issued the payment token as well as to confirm that the contents of the payment token (e.g., the payment amount) have not been changed. The payment token can, for example, include a number or a symbol representing of the amount of payment and a code or identifier used by the validating organization (bank or proxy) to confirm the validity of the payment token. The information can be encrypted or encoded, for example, in a 2D barcode or other symbolic representation. Other information can be included or associated with information in the payment token, such as the date of the token was issued, the expiration date (and/or time or length of time from issue) of the token, the anticipated payee and payee account number, the payor's bank and bank account number, a memo or note provided by the payor, and any other information useful for settling the transaction. In some embodiments the account numbers can used to reference private account number of the payor or the payee, so as not to expose the private account number during the transaction.

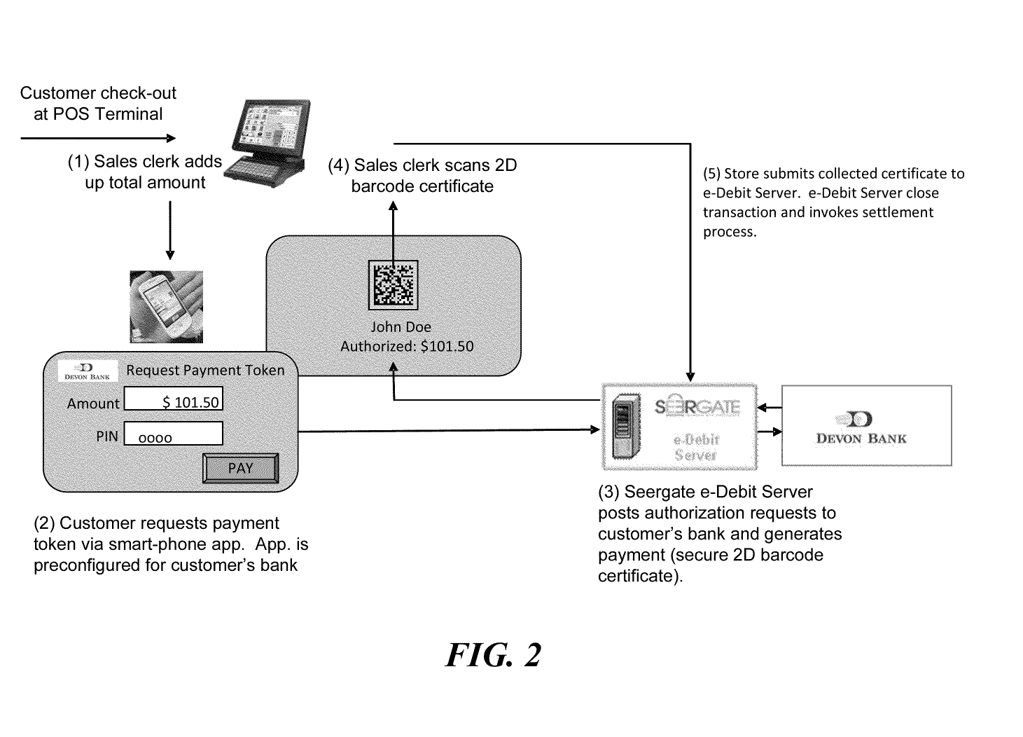

FIG. 2 shows an embodiment of a method for providing POS payment according to the invention. The process starts with payor check-out. At step (1), The sales clerk adds up the total amount to pay and announces or otherwise conveys it to the customer/payor. At step (2), the payor elects to pay with a payment token using the [e.g., e-Debit] smart-phone application. The payor starts the application which is preconfigured to access the [e.g., Seergate e-Debit or payor bank] server. The [Seergate e-Debit] server knows to route the request to the customer's bank based on configuration data stored in the smart-phone at configuration time or the payor's account on the server. These configuration data (Bank identification, customer identification) can be associated with a personal PIN or other secure access methodology. All these data can be validated by the authentication of the e-Banking system of the payor's bank. The payor can chose and change the personal PIN. The PIN can be maintained within the security perimeter of the e-Banking system. At step (2), the payor enters the amount to pay and their personal PIN. The can cause a secure sockets layer (SSL) secured message holding the amount and the PIN as well as the routing and customer data to be sent to the [Seergate e-Debit] service. The server submits the data to the e-Banking system of the bank and receives an approval or denial for the requested amount.

At step (3), the [Seergate e-Debit] server receives an authorization, for example, in the form of a certificate encoded in a 2D-barcode. The received data can also show the name of the customer in clear text. The certificate can, for example, be a short-lived one-time token together with the amount and transaction date. At step (4), the payor can present the token to the sales clerk, either physically, such as by handing their smart phone or PDA to the clerk for scanning or electronically, for example, using Wi-Fi or Blue Tooth to electronically convey the certificate information to the payee system.

At step (5), the payee system can store the certificate or forward the certificate to the [Seergate e-Debit] server for collection of funds and settlement of the transaction. The [e-Debit] server closes the authorized transaction and initiates the settlement process between the payor's bank and payee's bank.

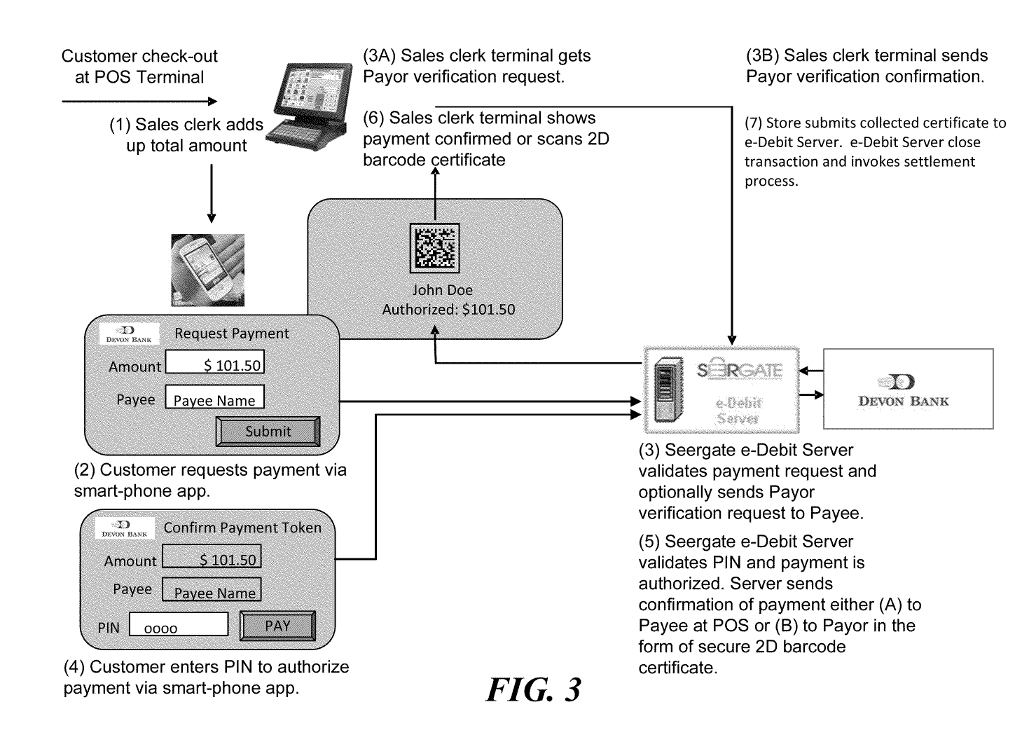

FIG. 3 shows an alternate embodiment of a method for providing POS payment according to the invention. The process starts with payor check-out. At step (1), The sales clerk adds up the total amount to pay and announces or otherwise conveys it to the customer/payor. At step (2), the payor elects to pay with the direct payment system using the [e.g., Seergate e-Debit] smart-phone application. The payor starts the application which is preconfigured to access the [e.g., Seergate e-Debit or payor bank] server. The server knows to route the request to the customer's bank based on configuration data stored in the smart-phone at configuration time or the payor's account on the server. The payor requests payment by providing the amount and the name of the payee in a payment request sent to the server. At step (3), the payment server receives the request and can validate the payment request (e.g. sufficient funds) by accessing the payor bank directly or indirectly (e.g., through an intermediate service or proxy). After the bank validates the request, at step (3A), the server can for example, optionally send to the payee POS terminal information to verify the identity of the payor. For example, the payee can receive a photograph, a fingerprint, a voice signature, a secret question or other validating device than can be used to verify the identity of the payor. At step (3B), the payee can either confirm the identity of the payor or send the information obtained from the payor (e.g., their picture, finger print, voice sample or answer back to the server for validation. After payor validation, the system can request payor confirmation.

At step (4), the server requests payor confirmation by asking the payor to provide their personal identification number (or PIN) to confirm authorization to make payment. At step (5) the server receives and validates the payor's PIN in order to confirm that payment is authorized. At step (6), the server can send a confirmation that payment has been authorized. In accordance with one embodiment of the invention, the confirmation can be sent to the payor, for example, in the form of a 2D barcode or a confirmation code or number that can be presented to the payee for scan or capture. The payor can transfer the 2D barcode, or confirmation code to the payee either physically (visually) or electronically, such as using wired or wireless technologies (e.g., Wi-Fi, Blue Tooth, Zigbee, IR, etc.). Alternatively, the server can send the confirmation code directly to the payee, such as at the POS terminal. The payee can prepare and present a receipt (e.g., either electric or paper) to the payor to confirm receipt of payment.

At step (7), the payee can settle the transaction. In one embodiment of the invention, the payee can store the 2D barcode (or the information stored therein) or the confirmation codes and present them at a later time to the server (intermediate service provider) or directly to the payor's bank for payment. In other embodiments of the invention, at the time the confirmation is issued, the intermediate service or the payor's bank can initiate an electronic funds transfer with the payee's bank, which can be completed in due course. In still other embodiments, the payee's bank and the payor's bank can aggregate the payment records of multiple transactions in order to determine a net payment that settles multiple transaction with a single EFT. The end result being that the payor's bank account is debited by the payment amount and the payees bank account it credited by the payment amount.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A system for point of sale payment comprising:
a payment server having access to a payor bank processing system;
a payor network terminal device connected to the payment server over a network, the payor network terminal including an application configured to communicate with the payment server to cause a payment to be made from the payor bank to a predefined payee bank;
wherein, the payment server is adapted and configured to receive payment requests, for a predefined amount, from the payor network terminal device over the network and submit a payment request to the payor bank processing system to confirm sufficiency of funds in a payor account and place a hold on the predefined amount and provide a certificate confirming the authorization of payment of the predefined amount to the payment server.

2. A method for point of sale payment using a computerized system for transferring payment, the computerized system including a computer server, having a data processing component and associated memory and being connected to a network, the method comprising:
receiving from a payee an indication of an amount due;
sending a request from a payor terminal over the network to the payment server requesting a payment token representing payment of the amount due;
validating the payor request to confirm sufficient funds in a payor account;
receiving from the payment server a payment token representing the amount due;
presenting the payment token to the payee; and
wherein the payee presents the payment token and payment is made from the payor account to the payee account.

3. A method for point of sale payment using a computerized system for transferring payment, the computerized system including a computer server, having a data processing component and associated memory and being connected to a network, the method comprising:
receiving from a payee an indication of an amount due;
sending a request from a payor terminal over the network to the payment server requesting a payment of the amount due to a payee;
validating the payor request to confirm sufficient funds in a payor account;
requesting confirmation from the payor to authorize payment of the amount due to the payee;
receiving confirmation from the payor to authorize payment of the amount due to the payee;
transferring funds in the amount due from the payor account to a payee account;
providing the payee with confirmation of payment of the amount due; and
providing the payor for a receipt for payment.
